(19) United States
(12) Patent Application Publication
(10) Pub. No.: US 2019/0212633 A1
(43) Pub. Date: Jul. 11, 2019

(54) IMAGING APPARATUS, IMAGING CONTROL METHOD, AND STORAGE MEDIUM

(71) Applicant: CANON KABUSHIKI KAISHA, Tokyo (JP)

(72) Inventor: Hiroya Honda, Hachioji-shi (JP)

(21) Appl. No.: 16/354,250

(22) Filed: Mar. 15, 2019

Related U.S. Application Data
(63) Continuation of application No. PCT/JP2017/033744, filed on Sep. 19, 2017.

(30) Foreign Application Priority Data
Sep. 27, 2016 (JP) 2016-188090

(51) Int. Cl. G03B 9/14; G03B 7/093; G03B 9/18

(52) U.S. Cl. CPC G03B 9/14; G03B 9/18; G03B 7/093

(57) ABSTRACT

An imaging apparatus includes an image sensor, a mechanical shutter configured to travel in a first direction and a second direction different from the first direction relative to an imaging plane of the image sensor, and a control unit configured to control imaging about an operation of the mechanical shutter. The control unit provides first imaging that causes the mechanical shutter to travel in the first direction in synchronization with an exposure of the image sensor and second imaging that causes the mechanical shutter to travel in the second direction in synchronization with the exposure of the image sensor. The control unit determines whether to perform one of the first imaging and the second imaging or to perform both the first imaging and the second imaging continuously based on an imaging mode and predetermined information on an imaging scene.

### CROSS-REFERENCE TO RELATED APPLICATIONS

This application is a Continuation of International Patent Application No. PCT/JP2017/033744, filed on Sep. 19, 2017, which claims the benefit of Japanese Patent Application No. 2016-188090, filed on Sep. 27, 2016, both of which are hereby incorporated by reference herein in their entirety.

### BACKGROUND OF THE INVENTION

### Field of the Invention

The present invention relates to an imaging apparatus having a plurality of mechanical shutters with different traveling (moving) directions in exposing an image sensor.

### Description of the Related Art

Some imaging apparatuses include a shutter with a mechanical front curtain configured to control an exposure start and a mechanical rear curtain configured to control an exposure end. Other imaging apparatuses have an electronic front curtain configured to electronically realize a function similar to that of the mechanical front curtain by rest scanning that resets electric charges in an image sensor configured to photoelectrically convert an object image and to output an electric signal. These imaging apparatuses can accurately image a changing object by improving the number of imageable number (frame rate).

For example, Japanese Patent Laid-Open No. (“JP”) 2-134625 discloses a shutter that alternately performs an opening control and a light shielding control in both a forward (or onward) travel and a backward (or return) travel through two mechanical curtains forming a slit for a forward travel exposure and a backward travel exposure, and improves a frame rate. JP 2011-146925 also discloses an imaging apparatus that includes an electronic front curtain that controls exposure starts from the upper and lower sides of an image sensor toward the center at the same time, a first mechanical rear curtain that travels from the top to the bottom and controls the light shielding, and a second mechanical rear curtain that travels from the bottom to the top and controls the light shielding. The imaging apparatus in JP 2011-146925 can improve the frame rate by moving the electronic front curtain from the top and the bottom of the image sensor to the center, and then by moving the first and second mechanical rear curtains so that they intersect each other at the center to shield the entire image sensor from the light.

However, the shutter disclosed in JP 2-134625 used for the imaging apparatus having the image sensor causes the following problem. In general, in the slit exposure that moves the two mechanical curtains, an object moving in a direction orthogonal to the traveling directions of the mechanical curtains causes a rolling shutter distortion that distorts an image due to the charge accumulation timing shifts in the image sensor from the exposure start to the exposure end. Then, the forward travel exposure and the backward travel exposure as disclosed in JP 2-134625 cause different rolling shutter distortions between the forward travel exposure and the backward travel exposure due to the different traveling direction of the mechanical curtains. In other words, the different rolling shutter distortions alternate between the odd-numbered images acquired by the forward travel exposure and the even-numbered images acquired by the backward travel exposure, and impairs the image continuity.

The imaging apparatus disclosed in JP 2011-146925 simultaneously drives the first and second mechanical rear curtains from the top and the bottom, unlike the conventional configuration, and thus generates a rolling shutter distortions different from that of the conventional one. As a result, the user who is accustomed to the conventional rolling shutter distortion gets confused.

### SUMMARY OF THE INVENTION

The present invention provides an imaging apparatus that can improve a frame rate with a mechanical shutter while suppressing a rolling shutter distortion.

An imaging apparatus according to one aspect of the present invention includes an image sensor configured to photoelectrically convert light from an object, a mechanical shutter configured to travel in a first direction and a second direction different from the first direction relative to an imaging plane of the image sensor, and a control unit configured to control imaging about an operation of the mechanical shutter. The control unit provides a control so as to provide first imaging that causes the mechanical shutter to travel in the first direction in synchronization with an exposure of the image sensor and second imaging that causes the mechanical shutter to travel in the second direction in synchronization with the exposure of the image sensor. The control unit determines whether to perform one of the first imaging and the second imaging or to perform both the first imaging and the second imaging continuously based on an imaging mode and predetermined information on an imaging scene, and controls the imaging in accordance with a determination result.

An imaging apparatus according to another aspect of the present invention includes an image sensor, a mechanical shutter configured to travel in a first direction and a second direction different from the first direction relative to an imaging plane of the image sensor, a control unit configured to control an exposure about an exposure operation using the image sensor, and an acquisition unit configured to acquire predetermined information on at least one of the number of travels and a traveling characteristic of the mechanical shutter. The control unit provides a control so as to provide first imaging that causes the mechanical shutter to travel in the first direction in synchronization with an exposure of the image sensor and second imaging that causes the mechanical shutter to travel in the second direction in synchronization with the exposure of the image sensor. When one of the first imaging and the second imaging is to be performed, the control unit determines based on the predetermined information which of the first imaging or the second imaging is to be performed, and controls the imaging in accordance with a determination result.

Further features of the present invention will become apparent from the following description of exemplary embodiments with reference to the attached drawings.

### BRIEF DESCRIPTION OF THE DRAWINGS

FIG. 1 is a block diagram illustrating a configuration of an imaging apparatus according to a first embodiment of the present invention.

FIG. 2 illustrates a configuration of a mechanical shutter according to the first embodiment.

FIGS. 3A and 3B illustrate a forward travel exposure and a backward travel exposure according to the first embodiment.

FIGS. 4A, 4B, and 4C illustrate round-travel imaging of an object across an entire imaging screen according to the first embodiment.

FIGS. 5A and 5B illustrate round-travel imaging of an object across part of an imaging screen according to the first embodiment.

FIG. 6 is a block diagram illustrating a configuration of an imaging control according to the first embodiment.

FIG. 7 is a flowchart illustrating a flow of imaging control processing according to the first embodiment.

FIG. 8 illustrates a method of determining the rolling shutter distortion according to the first embodiment.

FIGS. 9A and 9B illustrate a forward travel exposure and a backward travel exposure according to a second embodiment of the present invention.

FIGS. 10A to 10D illustrate a traveling timing detection for a shutter blade A according to the second embodiment.

FIGS. 11A to 11D illustrate a traveling timing detection for a shutter blade B according to the second embodiment.

FIGS. 12A and 12B illustrate an initial round-travel characteristic and an SH detection signal according to the second embodiment.

FIGS. 13A and 13B illustrate a post-change round-travel characteristic and the SH detection signal according to the second embodiment.

FIG. 14 is a block diagram illustrating a configuration about an imaging control according to the second embodiment.

FIGS. 15A and 15B are flowcharts illustrating a flow of imaging control processing according to the second embodiment.

### DESCRIPTION OF THE EMBODIMENTS

Referring now to the accompanying drawings, a description will be given of embodiments according to the present invention.

### First Embodiment

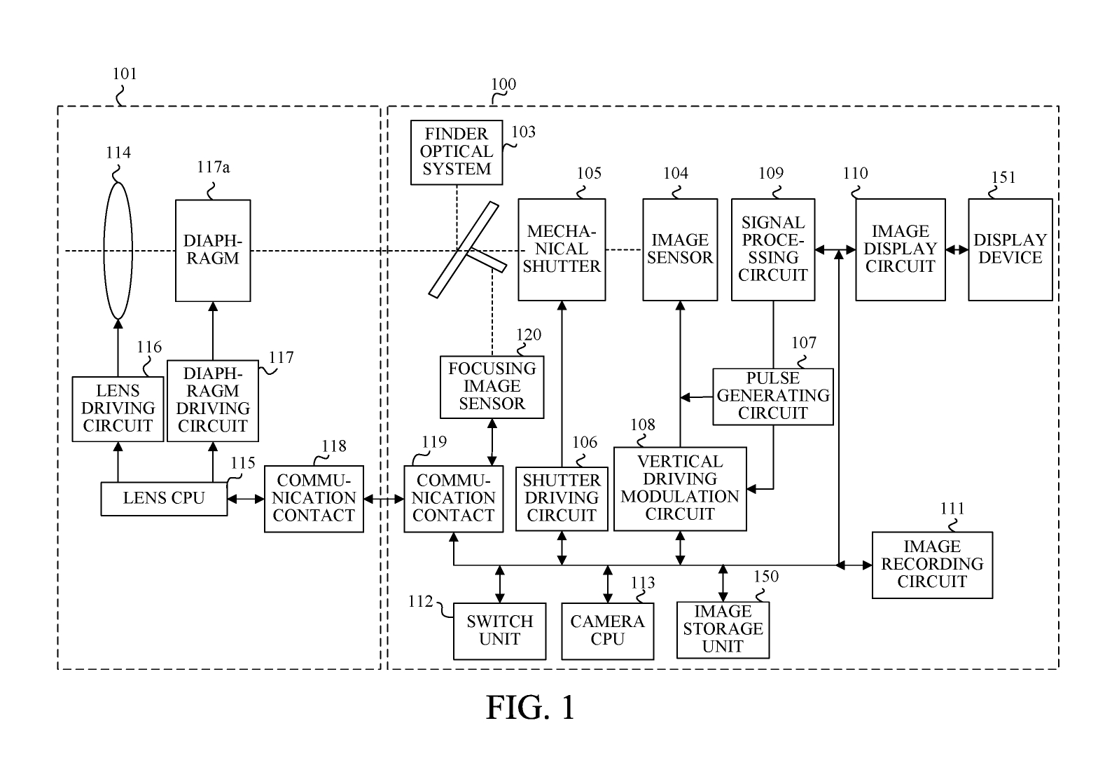

FIG. 1 illustrates an imaging apparatus (referred to as a camera body hereinafter) 100 according to a first embodiment of the present invention and an interchangeable lens unit (simply referred to as a lens unit hereinafter) 101 detachably mounted on the camera body 100. The configuration of the lens unit 101 will now be described.

An imaging lens 114 as an imaging optical system forms an object image by forming light from an object. In the drawing, the imaging lens 114 is expressed by a single lens, but actually includes a plurality of lenses such as a focus lens and a magnification-varying lens.

A lens CPU 115 controls focus driving and zoom driving of the imaging lens 114 via a lens driving circuit 116, and controls driving of a diaphragm (aperture stop) 117a via a diaphragm driving circuit 117. The lens CPU 115 communicates with the camera CPU 113 in the camera body 100 to be described later via a communication contact 118 in the lens unit 101 and a communication contact 119 in the camera body 100. For example, the lens CPU 115 transmits lens information to the camera CPU 113 via the communication contacts 118 and 119 in accordance with a request from the camera CPU 113.

Next follows a description of the configuration of the camera body 100. In a viewfinder observation state where a mirror 102 is disposed on an imaging optical path as illustrated in the figure, the light from the object that has passed through the imaging lens 114 and the diaphragm 117 is reflected by the mirror 102, and guided to a finder optical system 103 and a focusing image sensor 120. Thereby, the user (photographer) can observe the object image through the finder optical system 103. The camera CPU 113 recognizes the object through the focusing image sensor 120, and detects (calculates) a defocus amount for the object. A driving amount of the focus lens for obtaining an in-focus state on the object is transmitted to the lens CPU 115 through the communication contact 119, and the lens CPU 115 drives the focusing lens 115 for autofocusing (AF).

When an unillustrated release button is pressed by the user, the camera CPU 113 retreats the mirror 102 from the imaging optical path to transfer from the viewfinder observation state to an imaging state. Thereby, the light from the imaging lens 114 passes through a shutter opening in a mechanical shutter unit 105 and enters an image capturing image sensor (simply referred to as an image sensor hereinafter) 104 such as a CMOS sensor and a CCD sensor. Thereby, the image sensor 104 is exposed.

The image sensor 104 has a plurality of pixels, and each pixel photoelectrically converts the object image during exposure and accumulates electric charges corresponding to a luminance of the object image. A scanning clock (horizontal driving pulse) and a predetermined control pulse are supplied from a pulse generating circuit 107 to the image sensor 104, and the exposure is controlled using an electronic shutter (electronic front curtain) that sequentially resets a plurality of pixels. The vertical scanning clock out of the scanning clock generated by the pulse generating circuit 107 is modulated into a predetermined clock frequency by a vertical driving modulation circuit 108 and input to the image sensor 104. The vertical driving modulation circuit 108 determines a scanning pattern of the electronic shutter. The pulse generating circuit 107 also outputs a clock signal to a signal processing circuit 109 to be described later.

The mechanical shutter unit 105 has a first mechanical shutter 105a and a second mechanical shutter 105b each including a plurality of shutter blades (light shielding blades) although concrete configurations thereof will be described later. Each of the first and second mechanical shutters 105a and 105b can travel in a forward (or outward) travel (or movement) direction (first direction) and a backward (or return) travel direction (second direction) described below. Both of the first and second mechanical shutters 105a and 105b travel in the forward travel direction for a forward travel exposure of the image sensor 104, and both of them travel in the backward travel direction for a backward travel exposure of the image sensor 104. The camera CPU 113 controls driving of the first and second mechanical shutters 105a and 105b via a shutter driving circuit 106.

The signal processing circuit 109 performs correlated double sampling processing (CDS), autogain (AG) processing and other processing (color processing, gamma correction, etc.) for the electric signal generated by the electric charges read out of the image sensor 104, and generates image data. The generated image data is used by the camera CPU 113 to calculate a moving speed of the object. The image data is displayed as a captured image on a display device 151 via an image display circuit 110, or recorded on a recording medium, such as an unillustrated semiconductor memory, by an image recording circuit 111.

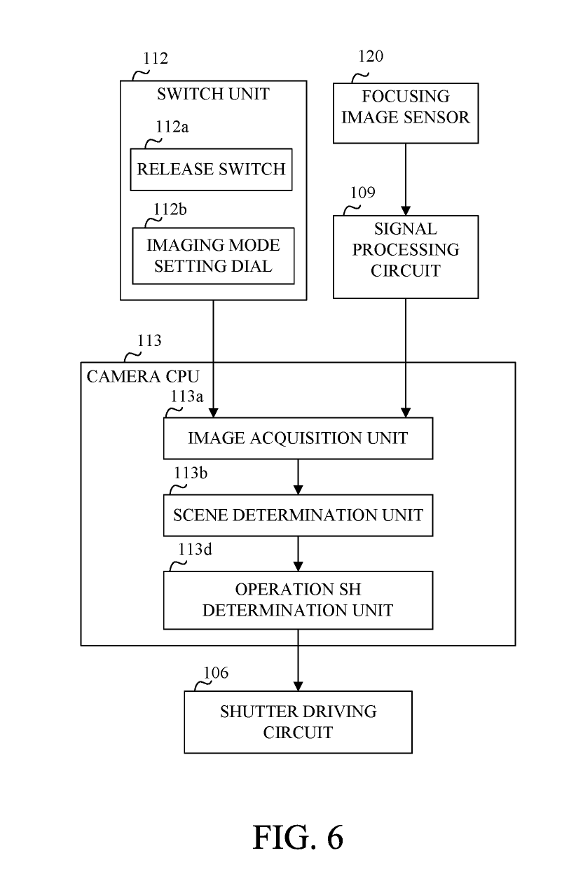

A switch unit 112 includes a plurality of switches and the like to be operated by the user. More specifically, it includes a main switch that turns on and off the main power supply of the camera body 100. The switch unit 112 also includes a release switch. When the release button is half-pressed, the camera is turned on (SW1 ON) to start an imaging preparation operation such as photometry and AF, and when it is fully pressed, it is turned on (SW 2 ON) to start an imaging operation, from the exposure of the image sensor 104 to display and record the image data. The switch unit 112 also includes an imaging mode setting dial operated by the user to set an arbitrary imaging mode. The release switch and the imaging mode setting dial are designated by reference numerals 112a and 112b in FIG. 6, respectively.

An information storage unit 150 stores information such as a traveling characteristic of the mechanical shutter unit 105 and the number of travels of each mechanical shutter detected by SH detection sensors 105c and 105d.

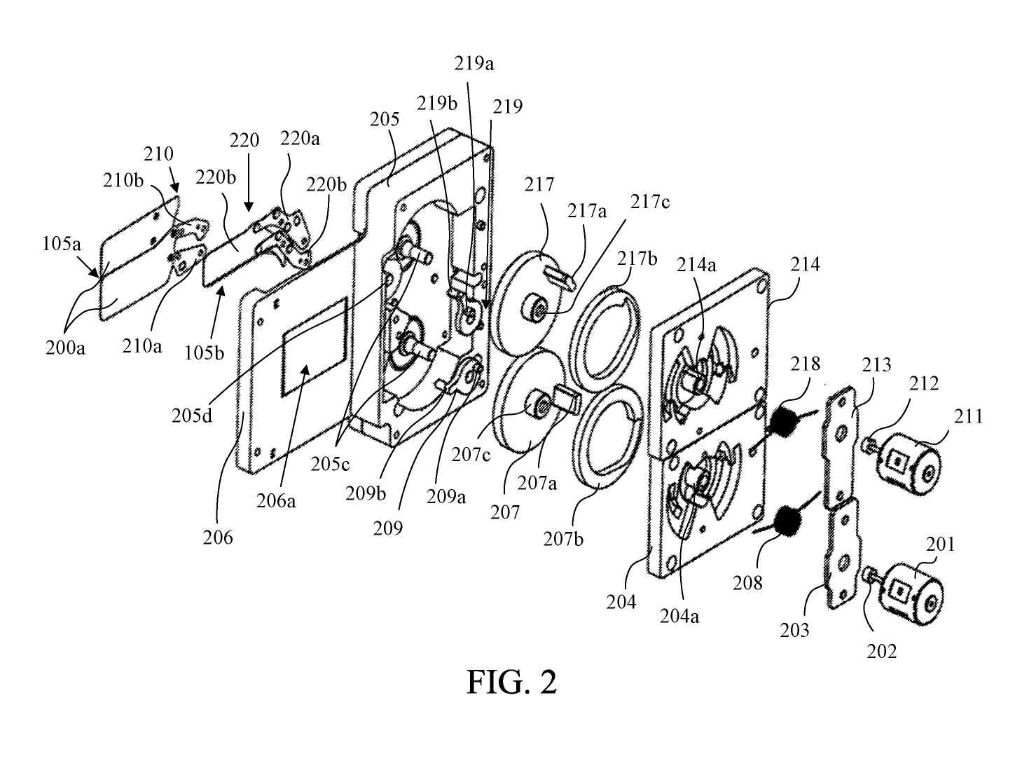

Referring now to FIG. 2, a description will be given of the configuration of the mechanical shutter unit 105 that can travel in the vertical direction (first and second directions) relative to the image sensor 104. A description will now be given of the configuration of the first mechanical shutter 105a. The first mechanical shutter 105a has a plurality of shutter blades 200a, a first motor 201, and a first pinion gear 202 integrally rotatably attached to the output shaft of the first motor 201. The first motor 201 is held by a first motor attachment plate 203. The first motor attachment plate 203 is fixed onto a first cover 204. The first cover 204 is fixed onto a cam base 205, and the cam base 205 is fixed onto a shutter base plate 206. The shutter base plate 206 has an opening 206a that allows the light from the object pass toward the image sensor 104.

The plurality of shutter blades 200a are rotatably connected to a first blade driving plate 210 (210a, 210b). These shutter blades 200a can move in accordance with the rotation of the first blade driving plate 210 between a light shielding position where the shutter blades 200a are unfolded so as to cover the opening 206a and shield the image sensor 104 from the light and a light introducing position where the shutter blades 200a is folded to retreat from the opening 206a and allow the light to pass.

A first cam disc 207 has a protrusion 207a and a central shaft hole portion 207c, and a disc weight 207b is attached to the first cam disc 207. The protrusion 207a is engaged with an arm of a first biasing spring 208. One of the two shaft portions 205c provided to the cam base 205 is engaged with the central shaft hole portion 207c. The inertial mass of the disk weight 207b is set larger than the total inertial mass of the plurality of shutter blades 200a, the first blade driving plate 210, and a first driving lever 209 described later.

A cylindrical portion 204a of the first cover 204 is inserted into a coil portion of the first biasing spring 208. The first driving lever 209 is rotatably attached to an unillustrated shaft portion provided on the cam base 205. A boss portion 209a of the first drive lever 209 is slidably engaged with an unillustrated cam groove portion formed in a back surface of the first cam disc 207. As the first cam disc 207 rotates, the cam groove portion thereof slides relative to the boss portion 209a of the first drive lever 209 and presses it, whereby the first drive lever 209 rotates.

The first blade driving plate 210 includes a first main driving plate 210a and a first auxiliary driving plate 210b. Both the first main driving plate 210a and the first auxiliary driving plate 210b are rotatably connected to the plurality of shutter blades 200a and are rotatably held by the shutter base plate 206. A shaft portion 209b provided on the arm of the first driving lever 209 is engaged with a driving hole portion provided in the first main driving plate 210a. Therefore, as the first driving lever 209 rotates, the first blade driving plate 210 also rotates, and the shutter blade 200a is driven between the light shielding position and the light introducing position. The first auxiliary driving plate 210b has a detection hole portion (not illustrated in FIG. 1) for allowing the SH detection sensor 105c described later to detect the traveling characteristic of the first mechanical shutter 105a.

Next follows the configuration of the second mechanical shutter 105b. The second mechanical shutter 105b has a plurality of shutter blades 200b, a second motor 211, and a second pinion gear 212 integrally rotatably attached to the output shaft of the motor 211. The second motor 211 is held by a second motor attachment plate 213. The second motor attachment plate 213 is fixed onto a second cover 214. The second cover 214 is fixed onto the cam base 205.

The plurality of shutter blades 200b are rotatably connected to a second blade driving plate 220 (220a, 220b). The shutter blades 200b can move in accordance with the rotation of the second blade driving plate 220 between a light shielding position where the shutter blades 200b is unfolded so as to cover the opening 206a and to shield the light toward the image sensor 104 and a light introducing position where the shutter blades 200b is folded so as to retreat from the opening 206a and allow the light to pass.

A second cam disc 217 has a protrusion 217a and a central shaft hole portion 217c, and a disc weight 217b is attached to the second cam disc 217. The protrusion 217a is engaged with an arm of a second biasing spring 218. The other of the two shaft portions 205c provided on the cam base 205 is engaged with the central shaft hole portion 217c. The inertial mass of the disc weight 217b is set larger than the total inertial mass of the plurality of shutter blades 200b, the second blade driving plate 220, and a second driving lever 219 described later.

A cylindrical portion 214a of the second cover 214 is inserted into the coil portion of the second biasing spring 218. The second driving lever 219 is rotatably attached to a shaft portion 205d provided to the cam base 205. A boss portion 219a of the second driving lever 219 is slidably engaged with an unillustrated cam groove portion formed in a back surface of the second cam disc 217. As the second cam disc 217 rotates, the cam groove portion in the second cam disc 217 slides relative to the boss portion 219a of the second drive lever 219 and presses it, whereby the second drive lever 219 rotates.

The second blade driving plate 220 includes a second main driving plate 220a and a second auxiliary driving plate 220b. Both the second main driving plate 220a and the second auxiliary driving plate 220b are rotatably connected to the plurality of shutter blades 200b and are rotatably held by the shutter base plate 206. A shaft portion 219b provided on the arm of the second driving lever 219 is engaged with a driving hole portion provided in the second main driving plate 220a. Therefore, as the second driving lever 219 rotates, the second blade driving plate 220 also rotates, and the shutter blade 200b is driven between the light shielding position and the light introducing position. The second auxiliary driving plate 220b is provided with a detection hole portion (not illustrated in FIG. 1) for enabling the SH detection sensor 105d described later to detect the traveling characteristic of the second mechanical shutter 105b.

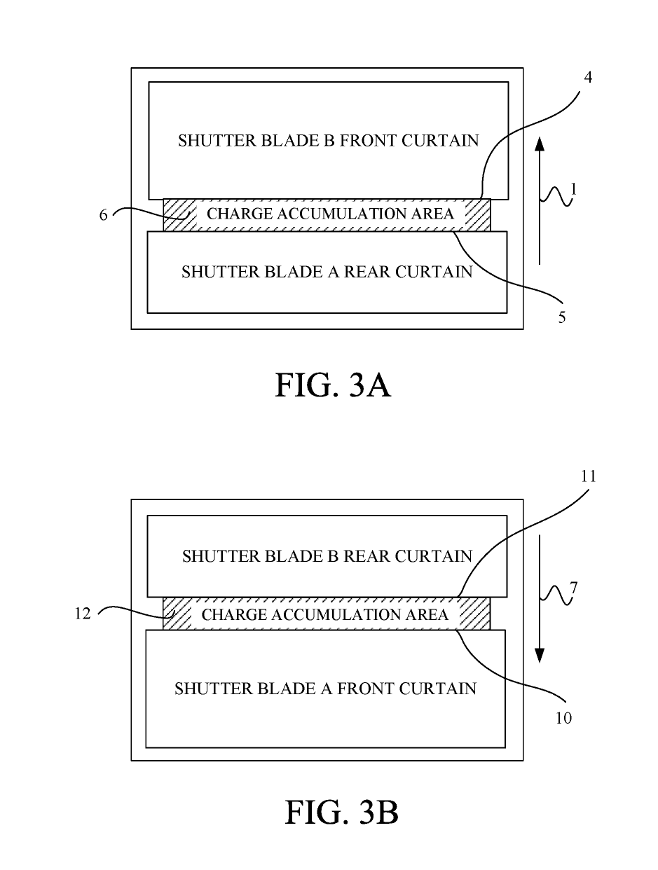

Referring now to FIGS. 3A and 3B, a description will be given of the forward travel exposure and the backward travel exposure by the first and second mechanical shutters 105a and 105b. FIGS. 3A and 3B illustrate the shutter blades 200a and 200b of the first and second mechanical shutters 105a and 105b and the image sensor 104 (charge accumulation area 6) viewed from the lens unit 101 side. These figures illustrate the plurality of shutter blades 200a of the first mechanical shutter 105a as shutter blades A, and the plurality of shutter blades 200b of the second mechanical shutter 105b as shutter blades B.

As illustrated in FIG. 3A, during the forward travel exposure in which the shutter blades A and B travel in a forward travel direction 1 from the bottom to the top, the shutter blade B becomes the front curtain and the shutter blade A becomes the rear curtain. As the release button is pressed and the SW2 is turned on, the shutter blade B first starts traveling in the forward travel direction 1 to the light introducing position from the light shielding position, and thereafter the shutter blade A starts traveling from the light introducing position to the light shielding position in the forward travel direction 1. A slit is formed between a bottom end 4 of the shutter blade B and a top end 5 of the shutter blade A. A pixel area or photoelectric conversion area on the image sensor 104 which receives the light passing through the slit is an electronic accumulation area 6. During the forward travel exposure, the charge accumulation operation in the bottom (lowest) pixel line is performed at the earliest timing in the image sensor 104, and the charge accumulation operation in the top (uppermost) pixel line is performed at the last timing. In other words, the charge accumulation scanning is performed in a direction from the bottom pixel line to the top pixel line. When the forward travel is completed, the shutter blade A shields the image sensor 104 from the light, and the charge reading scanning is performed in a direction from the bottom pixel line to the top pixel line.

Since the object image formed by the imaging lens 114 is inverted upside down on the image sensor 104, the charge accumulation scanning is performed in a direction from the bottom to the top as illustrated in FIG. 3A so that the object image is generated from the top to the bottom.

During the backward travel exposure illustrated in FIG. 3B in which the shutter blades A and B travel in a backward travel direction (second direction opposite to the first direction) 7 from the top to the bottom, the shutter blade A becomes the front curtain and the shutter blade B becomes the rear curtain. When the release button is pressed and the SW2 turns on, the shutter blade A first starts traveling in the backward travel direction 7 from the light introducing position toward the light shielding position, and the shutter blade B starts traveling from the light shielding position to the light introducing position in the backward travel direction 7. A slit is formed between a top end 10 of the shutter blade A and a bottom end 11 of the shutter blade B. A pixel area of the image sensor 104 which receives the light having passed through the slit is a charge accumulation area 12. During this backward travel exposure, the charge accumulation operation in the top (uppermost) pixel line is performed at the earliest timing by the image sensor 104, and the charge accumulation operation in the bottom (lowermost) pixel line is performed at the last timing. In other words, the charge accumulation scanning is performed in a direction from the top pixel line to the bottom pixel line. When the backward travel is completed, the image sensor 104 is shielded from the light by the shutter blades B, and the charge reading scanning is performed in a direction from the top pixel line to the bottom pixel line by the image sensor 104.

Where the forward travel and the backward travel alternate as described above, the reading timing of the charge accumulated in the image sensor 104 and the next shutter traveling timing are controlled so as not to overlap. More specifically, for example, after reading of the accumulated charges out of all the lines of the image sensor 104 is completed in accordance with the forward travel of the shutter blade A, the next charge accumulation of the image sensor 104 starts in synchronization with the backward travel of the shutter blade B.

As described above, since the object image formed by the imaging lens 114 is inverted upside down on the image sensor 104, the charge accumulation scanning is performed in a direction from the top to the bottom as illustrated in FIG. 3B and an image is generated from the bottom to the top in the object. Although the charge reading scanning is aligned with the imaging scanning direction in the above description, the reading scanning direction and the imaging scanning direction are not necessarily the same and the reading scanning may be always constant.

The shutter blade A and the shutter blade B serve as the front curtain and the rear curtain alternately in the forward travel exposure and the backward travel exposure for the round-travel exposure or so as to continue the forward travel imaging (first imaging) and the backward travel imaging (second imaging). Alternatively, only one of the forward travel imaging and the backward travel imaging may be performed.

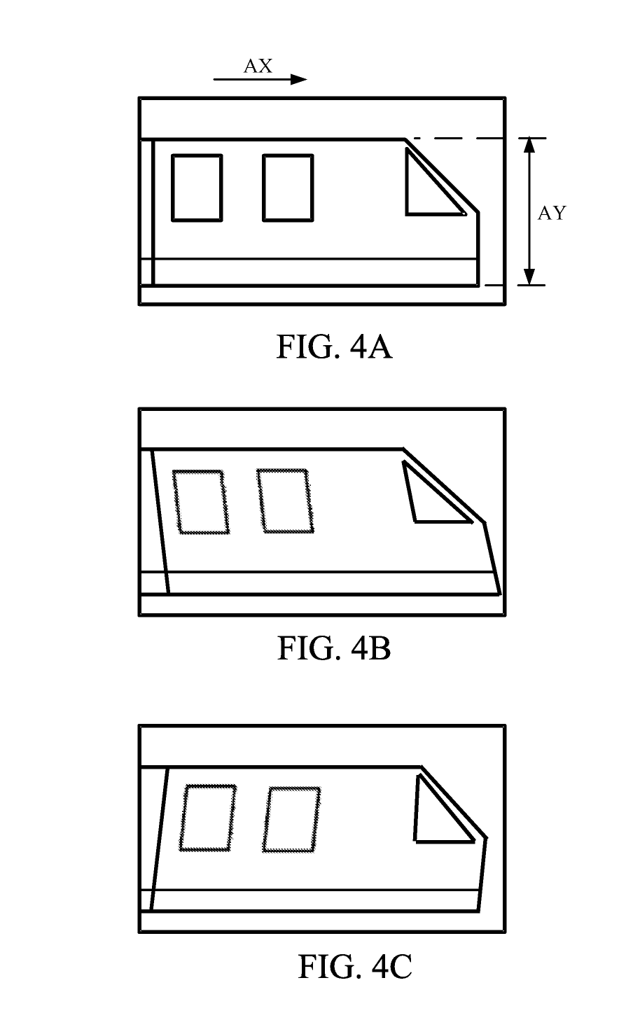

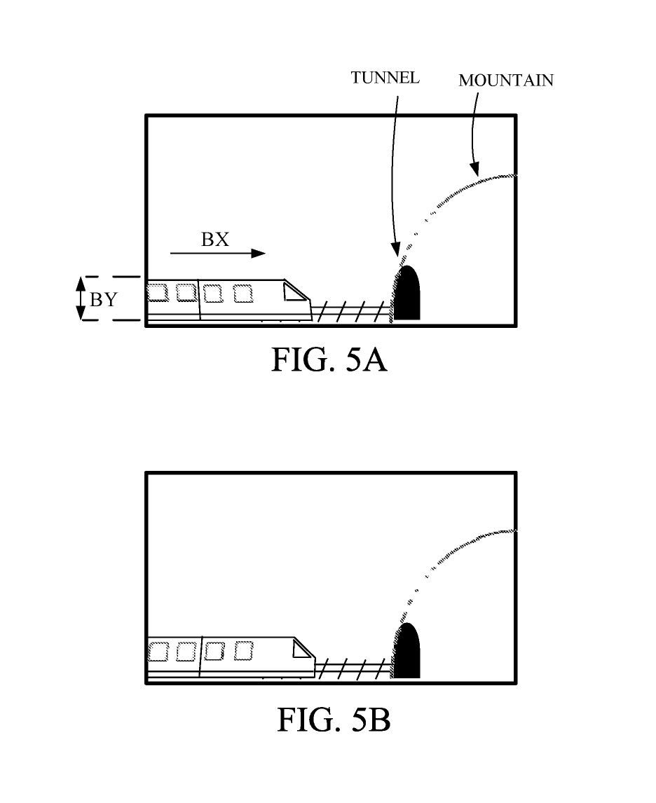

Referring now to FIGS. 4A to 4C and 5A and 5B, a description will be given of a captured image acquired in the forward travel imaging and the backward travel imaging for the object traveling across the imaging range (referred to as an imaging screen hereinafter) corresponding to an imaging angle of view through the lens unit 101. In FIGS. 4A to 4C, the object is an object (as a moving train at a high speed in this case) moving in a lateral direction orthogonal to a longitudinal direction as the traveling direction (first and second directions) of the shutter blades 200a to 200b.

FIG. 4A illustrates a lateral moving speed (referred to as the lateral moving speed hereinafter) AX in the imaging screen of the object is later than a predetermined speed and a vertical size (referred to as a height hereinafter) AY is a predetermined size or more. The charge accumulation timings of the upper side and the lower side of the object are more significantly different as the height AY is larger, but if the lateral moving speed AX of the object in the imaging screen is equal to or lower than the predetermined speed, no rolling shutter distortion occurs due to the difference in the charge accumulation timing. Even when the object stops, the same captured image as in FIG. 4A can be obtained.

FIG. 4B illustrates a captured image obtained by the forward travel imaging where the lateral moving speed AX in the imaging screen of the object is higher than the predetermined speed. In the forward travel imaging, the object moves in the lateral direction in a period from the charge accumulation timing for the lower side on the imaging screen (the upper side of the object) to the charge accumulation timing of the upper side (the lower side of the object). Therefore, the captured image causes the rolling shutter distortion in which the lower side of the object shifts to the upper side in the traveling direction of the object.

FIG. 4C illustrates a captured image obtained by the backward travel imaging when the lateral moving speed AX in the imaging screen of the object is higher than the predetermined speed. In the backward travel imaging, the object moves in the lateral direction in a period from the charge accumulation timing of the upper side on the imaging screen (the lower side of the object) to the charge accumulation timing of the lower side (the upper side of the object). Therefore, the captured image causes the rolling shutter distortion in which the upper side of the object shifts to the lower side in the traveling direction of the object. As can be seen from FIGS. 4B and 4C, the forward travel imaging and the backward travel imaging cause different rolling shutter distortions, in which the vehicle body and window of the train as the object are inclined diagonally in different directions. Hence, even if the high-speed continuous capturing mode to be described later is set, the round-travel imaging control for continuing the forward travel imaging and the backward travel imaging may be limited (or only one of the forward travel imaging and the backward travel imaging may be performed as one-way imaging control).

FIGS. 5A and 5B illustrate captured images acquired by the forward travel imaging for the same object as that in FIGS. 4B and 4C at an imaging distance longer (farther) than that in FIGS. 4B and 4C. In FIGS. 5A and 5B and FIGS. 4B and 4C, the object moves at the same lateral moving speed. However, the imaging distance in FIGS. 5A and 5B is longer than that in FIGS. 4B and 4C, and thus the lateral moving speed BX in the imaging screen is lower than the lateral moving speed AX on the imaging screen and the height BY of the object in the vertical direction is smaller than the height AY Hence, in FIGS. 5A and 5B, a difference in charge accumulation timing between the upper side and the lower side on the imaging screen is smaller than that in FIGS. 4B and 4C and inclination amounts of the vehicle body and window are smaller than those in FIGS. 4B and 4C.

Referring now to FIG. 6, a description will be given of an imaging control performed by the camera CPU 113 as control unit in accordance with information on imaging. The information on the imaging contains information on an imaging mode set by the user through the imaging mode setting dial 112b in the switch unit 112 and information on an object (imaging scene) detected from the image data obtained by using the focusing image sensor 120 or the like.

The camera CPU 113 includes an information acquisition unit 113a, a scene determination unit 113b, and an operation SH determination unit 113d. The information acquisition unit 113a acquires information on the imaging mode (referred to as imaging mode information hereinafter) set by the user through the imaging mode setting dial 112b. The information acquisition unit 113a acquires the image data into which the signal processing circuit 109 converts the image obtained by the focusing image sensor 120.

The information acquisition unit 113a sends the acquired imaging mode information and image data to the scene determination unit 113b. Based on the imaging mode information from the information acquisition unit 113a, the scene determination unit 113b selects a one-way imaging control (first imaging control) that performs only one of the forward travel imaging or the backward travel imaging is to be performed, or a round-travel imaging control (the second imaging control) that performs both of them continuously. The scene determination unit 113b detects (acquires) the height AY and the lateral moving speed AX of the object on the imaging screen as the information of the object from the image data acquired from the information acquisition unit 113a. Then, it is determined based on the height AY and the lateral moving speed AX of the object whether the rolling shutter distortion occurs, or whether the imaging scene includes an object that causes the rolling shutter distortion. A method of this determination will be described later in detail.

The operation SH determination unit 113d determines one of the one-way imaging control and the round-travel imaging control based on the imaging mode information and the determination result of the object in the scene determination unit 113b (about whether the height AY and/or the lateral moving speed AX cause the rolling shutter distortion). This determination will also be described in detail later. The imaging control determined by the operation SH determination unit 113d is transmitted to the shutter driving circuit 106. The shutter driving circuit 106 performs the transmitted imaging control.

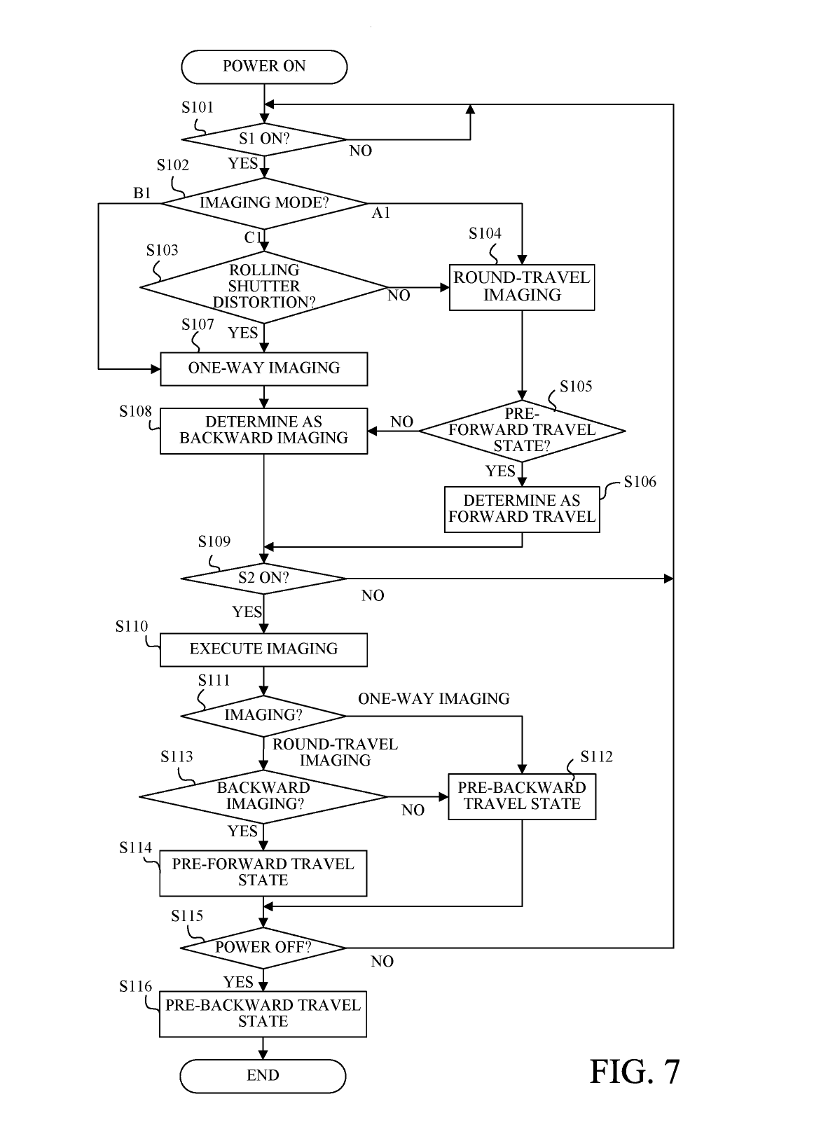

Referring now to a flowchart in FIG. 7, a description will be given of a flow of the above imaging control processing (imaging control method). The camera CPU 113 as a computer executes this processing in accordance with an imaging control program as a computer program. First, in the step S101, when the camera CPU 113 detects that the SW1 in the release switch 112a is turned on, it proceeds to the step S102.

In the step S102, the camera CPU 113 detects the imaging mode set by the imaging mode setting dial 112b (obtains the imaging mode information), and determines which of an A1 mode, a B1 mode, and a C1 mode the detected imaging mode is. Now, in an example, assume that that a low-speed continuous capturing mode is the B1 mode and a high-speed continuous capturing mode is the A1 mode, in which the continuous capturing speed is faster than that of the low-speed continuous capturing mode. A mode for determining the imaging control based on the detection result of the object (imaging scene) is the C1 mode. When the imaging mode is the A1 mode, the camera CPU 113 proceeds to the step S104, and when it is the B1 mode, it proceeds to the step S107. If the mode is the C1 mode, the flow proceeds to the step S103.

In the step S103, the camera CPU 113 detects the information on the object (imaging scene) from the image data obtained by the focusing image sensor 120. More specifically, it detects the height AY and the lateral moving speed AX of the object on the imaging screen. Then, it is determined whether the rolling shutter distortion occurs based on a determination method to be described later using the height AY and lateral moving speed AX. If it is determined that no rolling shutter distortion occurs, then the flow proceeds to the step S104, and if it is determined that the rolling shutter distortion occurs, then the flow proceeds to the step S107.

In the step S104, the camera CPU 113 determines that the imaging control to be executed this time is the round-travel imaging control as the SW2 in the release switch 112a turns on, and the flow proceeds to the step S105.

In the step S105, the camera CPU 113 determines whether or not the current state of the shutter unit 105 is in the pre-forward travel state in which the shutter blade A is located at the light introducing position and the shutter blade B is located at the light shielding position. If it is in the pre-forward travel state, the camera CPU 113 proceeds to the step S106. If the current state of the shutter unit 105 is in the pre-backward travel state in which the shutter blade A is located at the light shielding position and the shutter blade B is located at the light introducing position, the flow proceeds to the step S108.

On the other hand, in the step S107, the camera CPU 113 determines that the imaging control to be executed this time is the one-way imaging control and proceeds to the step S108.

In the step S108, the camera CPU 113 determines that the imaging control to be executed this time is the backward travel imaging, and proceeds to the step S109.

In the step S109, when the camera CPU 113 detects that the SW2 in the release switch 112a turns on, the flow proceeds to the step S110, and otherwise the camera CPU 113 returns to the step S101.

In the step S110, the camera CPU 113 executes the imaging control determined prior to the step S108 and proceeds to the step S111.

In the step S111, the camera CPU 113 determines whether the imaging control executed in the step S110 was the one-way imaging control or round-travel imaging control. If it is the one-way imaging control, the flow proceeds to the step S112 and if it is the round-travel imaging control, the flow proceeds to the step S113.

In the step S112, the camera CPU 113 sets the shutter unit 105 to the above pre-backward travel state and proceeds to the step S115.

In the step S113, the camera CPU 113 determines whether the imaging control determined in the step S110 was the backward travel imaging control. If it was the forward travel imaging control, the camera CPU 113 proceeds to the step S112 to set the shutter unit 105 to the pre-backward travel state and proceeds to the step S115. If it is the backward travel imaging control, the flow proceeds to the step S114.

In the step S114, the camera CPU 113 sets the shutter unit 105 to the above pre-forward travel state and proceeds to the step S115.

In the step S115, the camera CPU 113 determines whether or not the camera body 100 has been powered off by the main switch in the switch unit 112.

If it is not powered off, the camera CPU 113 returns to the step S101, and if it is powered off, the flow proceeds to the step S116.

In the step S116, the camera CPU 113 sets the shutter unit 105 to the pre-backward travel state and ends this processing.

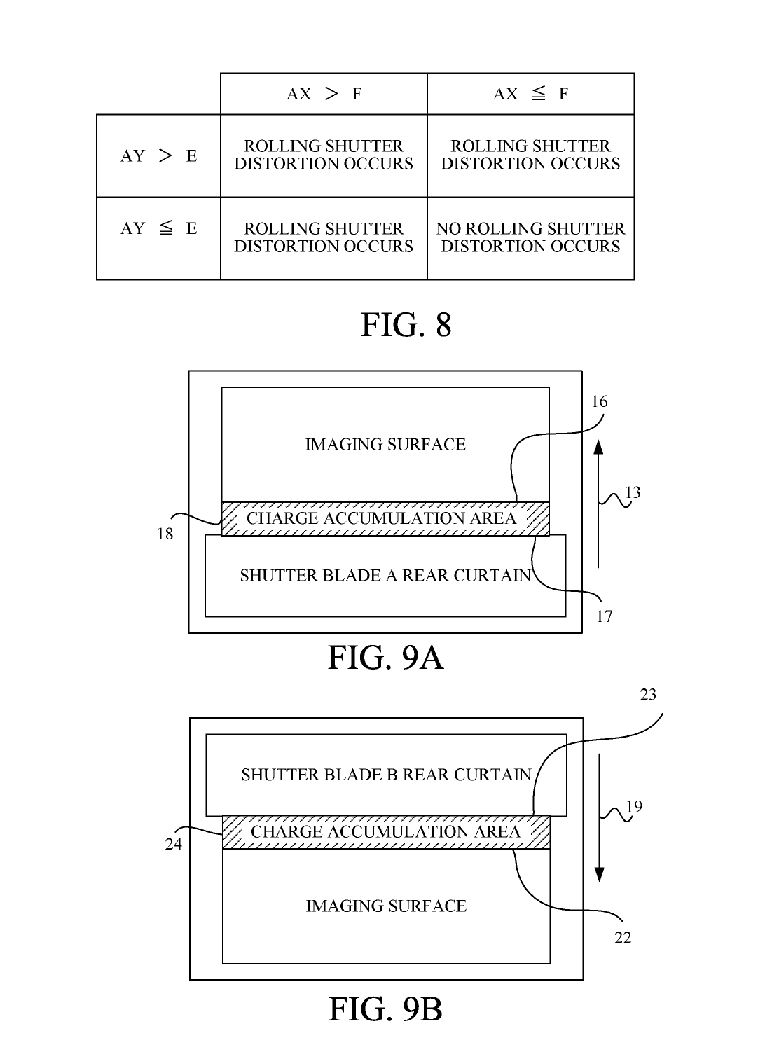

Referring now to FIG. 8, a description will be given of a method of determining whether the rolling shutter distortion occurs in the step S103. Whether or not the rolling shutter distortion occurs depends on the height AY and the lateral moving speed AX of the object on the imaging screen. More specifically, no rolling shutter distortion occurs if the height AY of the object is a height threshold (predetermined size) E or less and the lateral moving speed AX is a speed threshold (predetermined speed) F or less, and the rolling shutter distortion occurs otherwise. In other words, the rolling shutter distortion occurs when the lateral moving speed AX is higher than the speed threshold F regardless of the height AY of the object, and if the height AY of the object is larger than the height threshold E regardless of the lateral moving speed AX (≠0).

The method of determining the rolling shutter distortion is merely illustrative, and another determination method may be used.

While this embodiment describes that the camera CPU 113 determines which of the forward travel imaging control and the backward travel imaging control is to be used for the one-way imaging control, but the user may arbitrarily set it. The user may arbitrarily set which of the one-way imaging control and the round-travel imaging control is to be performed based on the information on the imaging.

### Second Embodiment

Next follows a description of a second embodiment according to the present invention. The camera body 100 according to this embodiment has the same configuration as that of the first embodiment, but the shutter blade A serves as the rear curtain in the forward travel imaging and the shutter blade B serves as the rear curtain in the backward travel imaging. This embodiment operates or moves the front curtain by the electronic shutter (referred to as an electronic front curtain hereinafter) prior to moving the rear curtain in each of the forward travel imaging and the backward travel imaging.

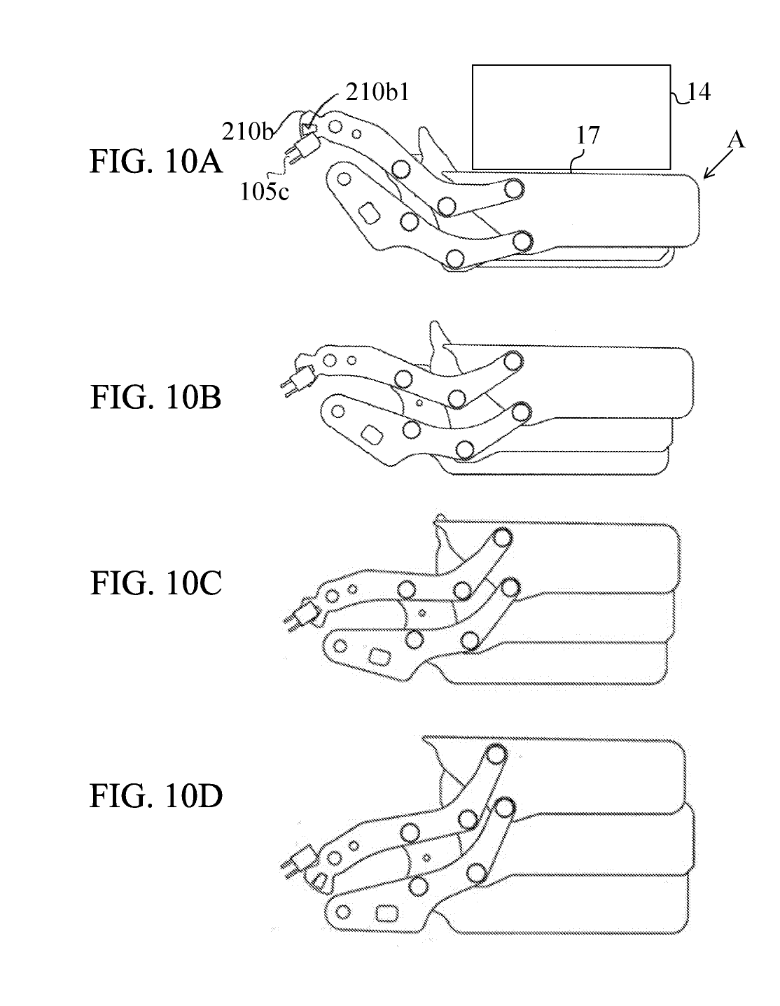

Referring now to FIGS. 9A and 9B, a description will be given of the forward travel exposure and the backward travel exposure according to this embodiment. FIGS. 9A and 9B illustrate the shutter blade A (200a), the shutter blade B (200b), and the image sensor 104 (the charge accumulation area 6) viewed from the lens unit 101 side. In this embodiment, the imaging plane 14 on the image sensor 104 exposes since the shutter blades as the front curtain are not used.

In the forward travel exposure illustrated in FIG. 9A, when the release button is pressed and the SW2 is turned on, reset scanning for sequentially resetting the accumulated charges is performed in a forward travel direction 13 from the bottom to the top of the imaging plane 14, whereby the electronic curtain 16 starts traveling in the forward travel direction 13. The camera CPU 113 performs this operation as the first electronic front curtain control. Thereafter, the shutter blade A as a mechanical rear curtain starts traveling in the forward travel direction 13. From the top end 17 of the shutter blade A, the image area corresponding to the slit described in FIG. 3A or the charge accumulation area 18 photoelectrically converts the incident light. During the forward travel exposure, the charge accumulation operation in the bottom pixel line in the image sensor 104 is performed at the earliest timing, and the charge accumulation operation in the top pixel line is performed at the last timing. In other words, the charge accumulation scanning is performed in a direction from the bottom pixel line to the top pixel line. When the forward travel is completed, the shutter blades A shield the image sensor 104 from the light, and the charge reading scanning is performed in a direction from the bottom pixel line to the top pixel line.

As also described in the first embodiment, the object image formed by the imaging lens 114 is inverted upside down on the image sensor 104, and the charge accumulation scanning illustrated in FIG. 9A generates an image in a direction from the top to the bottom of the object.

In the backward travel exposure illustrated in FIG. 9B, when the release button is pressed and the SW2 is turned on, reset scanning for sequentially resetting accumulated charges is performed in a backward travel direction 19 in a direction from the top to the bottom of the imaging plane 14, whereby an electronic curtain 22 starts traveling in the backward travel direction 19. The camera CPU 113 performs this operation as the second electronic front curtain control. Thereafter, the shutter blade B as the mechanical rear curtain starts traveling in the backward travel direction 19. From the bottom end 23 of the shutter blade B, the pixel area corresponding to the slit described in FIG. 3B or the charge accumulation area 24 photoelectrically converts the incident light. During the backward travel exposure, the charge accumulation operation in the top pixel line in the image sensor 104 is performed at the earliest timing, and the charge accumulation operation in the bottom the pixel line is performed at the last timing. In other words, the charge accumulation scanning is performed in a direction from the top pixel line to the bottom pixel line. When the backward travel is completed, the image sensor 104 is shielded from the light by the shutter blade B, and the charge reading scanning is performed in a direction from the top pixel line to the bottom pixel line by the image sensor 104.

Even in the imaging using the electronic front curtain, similar to the first embodiment, where the forward travel and the backward travel alternate, the reading timing of the charge accumulated in the image sensor 104 and the next shutter traveling timing are controlled so as not to overlap.

As described above, since the object image formed by the imaging lens 114 is inverted upside down on the image sensor 104, the charge accumulation scanning is performed in a direction from the top to the bottom as illustrated in FIG. 9B and an image is generated from the bottom to the top in the object. Although the charge reading scanning is aligned with the imaging scanning direction in the above description, the reading scanning direction and the imaging scanning direction are not necessarily the same and the reading scanning may be always constant.

The shutter blades A and the shutter blades B serve as the front curtain and the rear curtain alternately in the forward travel exposure and the backward travel exposure for the round-travel exposure or so as to continue the forward travel imaging and the backward travel imaging. Alternatively, only one of the forward travel imaging and the backward travel imaging may be performed.

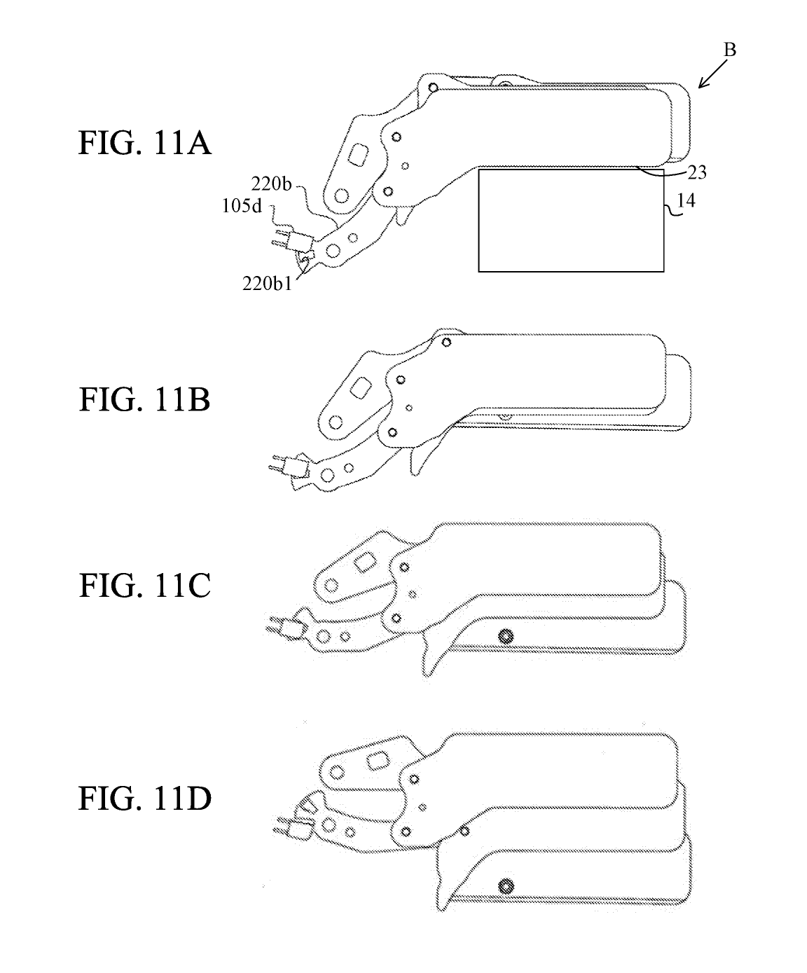

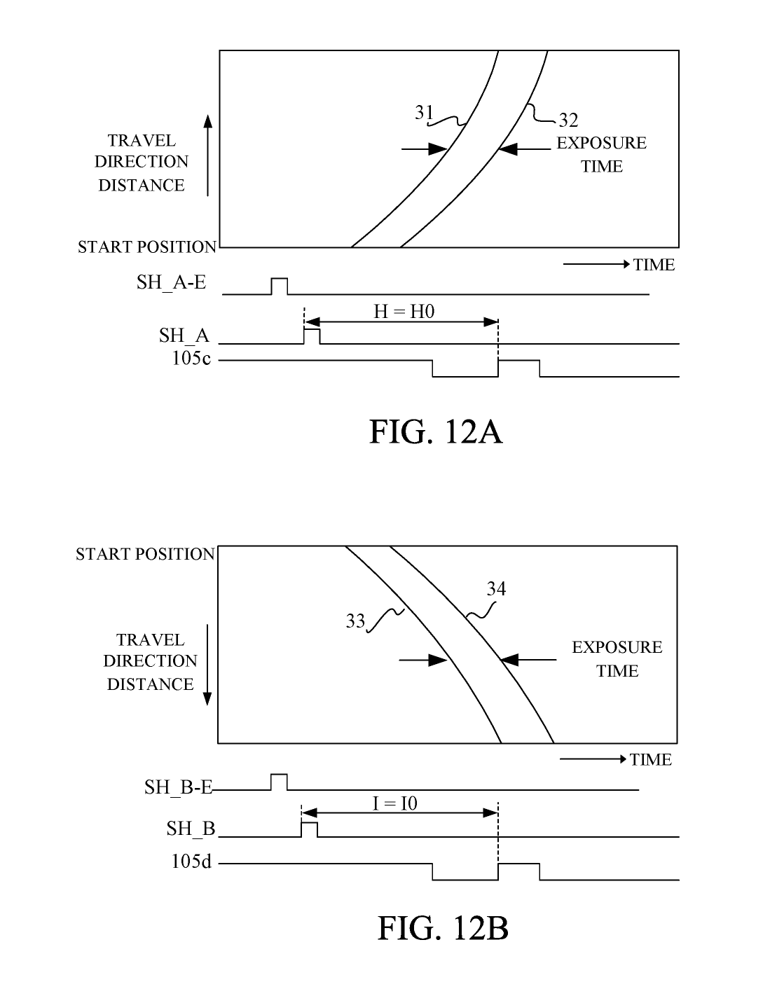

Referring now to FIGS. 10A to 10D and 11A to 11D, a description will be given of the traveling timing detections of the shutter blades A and B. FIGS. 10A to 10D illustrate a relationship between the shutter blade A and the SH detection sensor 105c in the forward travel exposure. FIGS. 11A to 11D illustrate a relationship between the shutter blade B and the SH detection sensor 105d in the backward travel exposure.

Each of the SH detection sensors 105c and 105d includes a photo interrupter (PI) or a photo reflector (PR) having a light emitting portion and a light receiving portion configured to receive detection light from the light emitting portion. The SH detection sensor 105c detects the traveling timing of the shutter blade A by detecting the switching of the presence and absence of the received detection light as the first blade driving plate 210b rotates. Similarly, the SH detection sensor 105d detects the traveling timing of the shutter blade B by detecting the switching of the presence and absence of the received detection light as the second blade driving plate 220b rotates. Each SH detection sensor outputs a low signal as the SH detection signal when the detection light is received and outputs a high signal as the SH detection signal when the detection light is not received.

As illustrated in FIGS. 10A and 11A, the first blade driving plate 210b and the second blade driving plate 220b respectively have detection holes 210b1 and 220b1 that transmit the detection light from the light emitting portions of the SH detection sensors 105c and 105d and enable the light receiving portions to receive the light. In the first and second blade driving plate 210b and 220b, portions around the detection holes 210b1 and 220b1 (referred to as light shielding portions hereinafter) cover the light receiving portions and the detection light is blocked from being received.

FIG. 10A illustrates a state just after the shutter blade A starts traveling in the forward travel exposure. More specifically, the top end 17 of the shutter blade A illustrated also in FIG. 9A is located below the bottom end of the imaging plane 14, and the light enters the entire area of the imaging plane 14. In this state, since the light receiving portion of the SH detection sensor 105c is covered by the light shielding portion of the first auxiliary driving plate 210b and receives no detection light, a high signal is output from the SH detection sensor 105c.

In FIG. 10B, the shutter blade A travels in the forward travel direction from the state illustrated in FIG. 10A, while its top end 17 is located at the center of the imaging plane 14 and only the upper part of the imaging plane 14 from the center receives the light. In this state, since the light receiving portion of the SH detection sensor 105c receives the detection light that has passed through the detection hole portion 210b1 in the first auxiliary driving plate 210b, a low signal is output from the SH detection sensor 105c.

FIG. 10C illustrates the shutter blade A further travels in the forward travel direction from the state in FIG. 10B, its top end 17 is located above the center of the imaging plane 14, and the light enters only an area above the top end 17 of the imaging plane 14. In this state, since the light receiving portion of the SH detection sensor 105c is covered by the light shielding portion of the first auxiliary driving plate 210b and receives no detection light, a high signal is output from the SH detection sensor 105c.

FIG. 10D illustrates that the shutter blade A completes traveling in the forward travel direction and the entire area of the imaging plane 14 is shielded from the light. In this state, since the light receiving portion of the SH detection sensor 105c is not covered with the light shielding portion of the first auxiliary driving plate 210b and receives the detection light, the SH detection sensor 105c outputs a low signal. Hence, the SH detection signal output from the SH detection sensor 105c in the forward travel exposure changes in order of high, low, high, and low as the shutter blade A travels.

FIG. 11A illustrates a state just after the shutter blade B starts traveling in the backward travel exposure. More specifically, a bottom end 23 of the shutter blade B illustrated also in FIG. 9B is located above the top end of the imaging plane 14, and the light enters the entire area of the imaging plane 14. In this state, since the light receiving portion of the SH detection sensor 105d is covered with the light shielding portion of the second auxiliary driving plate 220b and receives no detection light, the high detection signal is output from the SH detection sensor 105d.

FIG. 11B illustrates that the shutter blade B travels in the backward travel direction from the state of FIG. 11A, its bottom end 23 is located above the center of the imaging plane 14, and the light enters only the area below the bottom end 23 of the imaging plane 14. In this state, since the light receiving portion of the SH detection sensor 105d receives the detection light that has passed through the detection hole portion 220b1 in the second auxiliary driving plate 220b, a low signal is output from the SH detection sensor 105d.

FIG. 11C illustrates the shutter blade B further travels in the backward travel direction from the state in FIG. 11B, its bottom end 23 is located at the center of the imaging plane 14, and the light enters the area below the center in the imaging plane 14. In this state, since the light receiving portion of the SH detection sensor 105d is covered with the light shielding portion of the second auxiliary driving plate 220b and receives no detection light, the high detection signal is output from the SH detection sensor 105d.

FIG. 11D illustrates that the shutter blade B completes traveling in the backward travel direction and the entire area of the imaging plane 14 is shielded from the light. In this state, since the light receiving portion of the SH detection sensor 105d is not covered with the light shielding portion of the second auxiliary driving plate 220b and receives the detection light, the SH detection sensor 105d outputs a low signal. Thus, the SH detection signal output from the SH detection sensor 105d in the backward travel exposure changes in order of high, low, high, and low as the shutter blade B travels.

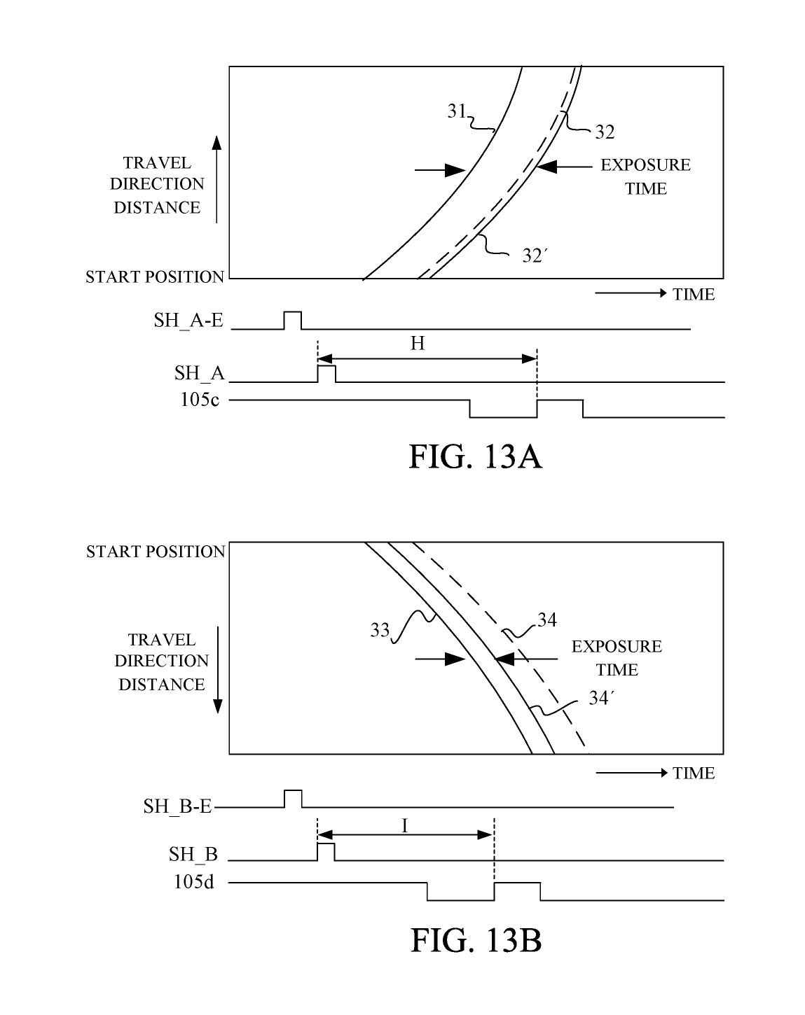

FIG. 12A illustrates a (referred to as initial hereinafter) round-travel characteristic of the shutter blade A in the forward travel exposure at the factory shipment of the camera body 100 and the SH detection signal output from the SH detection sensor 105c. FIG. 12B illustrates the initial round-travel characteristic of the shutter blades B in the backward travel exposure and the SH detection signal output from the SH detection sensor 105d.

In FIG. 12A, the electronic front curtain (reset scanning) starts traveling from the bottom end (start position) on the imaging plane when a front curtain traveling start signal SH_A-E for the forward travel exposure becomes high, and the speed gradually increases toward the top as indicated by a curve 31. Thereafter, as the blade traveling start signal SH_A becomes high, the shutter blade A as the rear curtain also starts traveling from the bottom and the speed gradually increases toward the top as illustrated by a traveling curve 32.

Then, when the top end of the shutter blade A reaches the center of the imaging plane 14 as described in FIG. 10B, the SH detection signal from the SH detection sensor 105c changes from low to high. Assume that a time period from the blade traveling start signal SH_A to the time when the SH detection signal changes from low to high is forward travel characteristic time H and an initial forward traveling characteristic time H is specifically referred to as initial forward traveling characteristic time H0. The initial forward traveling characteristic time H0 is stored in the information storage unit 150.

In FIG. 12B, when a front curtain traveling start signal SH_B-E for the backward travel exposure becomes high, the electronic front curtain (reset scanning) starts traveling from the top end (start position) on the imaging plane, and the speed gradually increases toward the bottom as illustrated by a traveling curve 33. Thereafter, when the blade traveling start signal SH_B becomes high, the shutter blade B as the rear curtain also starts traveling from the top and the speed gradually increases toward the bottom as illustrated by a traveling curve 34.

Then, as described with reference to FIG. 11C, when the bottom end of the shutter blade B reaches the center of the imaging plane 14, the SH detection signal from the SH detection sensor 105d changes from low to high. Assume that a time period from the blade traveling start signal SH_B to the time when the SH detection signal changes from low to high is backward traveling characteristic time I and an initial backward traveling characteristic time I is specifically referred to as initial backward traveling characteristic time I0. The initial backward traveling characteristic time I0 is also stored in the information storage section 150.

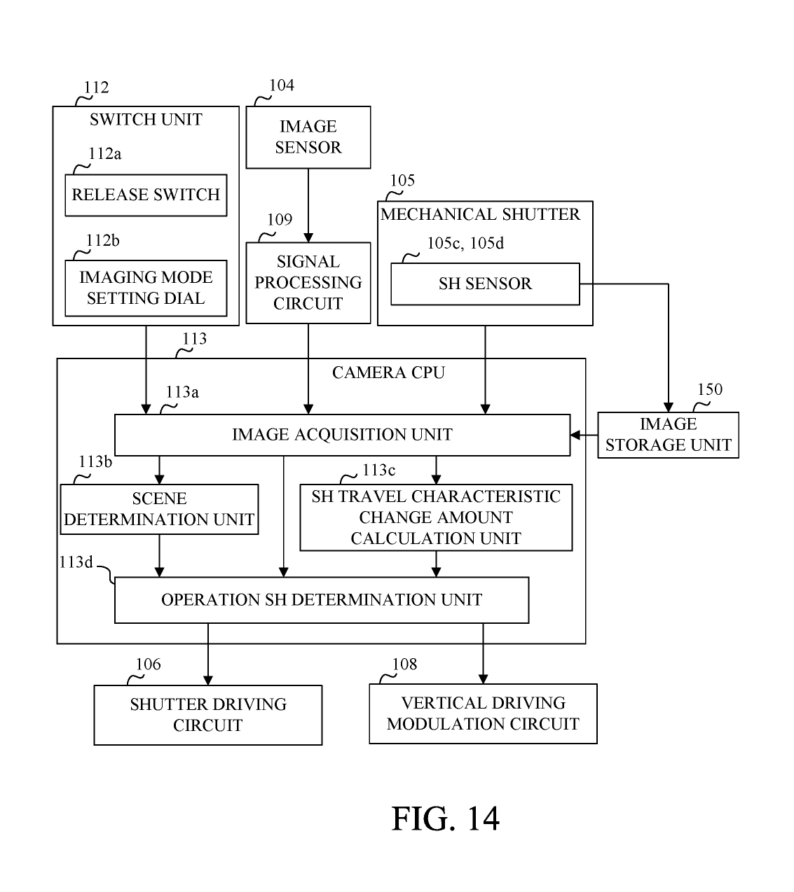

FIGS. 13A and 13B illustrate changes of the traveling characteristics of the shutter blades A and B in the forward and backward travel exposures due to abrasions or the like caused by the use of the camera body 100, and the SH signals from the SH detection sensors 105c and 105d. In these figures, the traveling curve 31 of the electronic front curtain does not change relative to the traveling curves illustrated in FIGS. 12A and 12B.

On the other hand, in the forward travel exposure illustrated in FIG. 13A, the traveling curve 32′ of the shutter blade A shows that the actual traveling start relative to the blade traveling start signal SH_A is later than the initial traveling curve 32. The forward traveling characteristic time H at this time is longer than the initial forward traveling characteristic time H0, and a difference between H and H0 will be referred to as forward traveling characteristic change amount ΔH.

ΔH=H−H0

The forward traveling characteristic change amount ΔH is stored in the information storage unit 150.

In the backward travel exposure illustrated in FIG. 13B, the traveling curve 34′ of the shutter blade B shows that the actual traveling start relative to the blade traveling start signal SH_B is much earlier than the initial traveling curve 34. The backward travel characteristic time I at this time is shorter than the backward travel initial traveling characteristic time I0 and a difference between I and I0 will be referred to as backward traveling characteristic change amount ΔI.

ΔI=I−I0

The backward traveling characteristic change amount ΔI is also stored in the information storage unit 150.

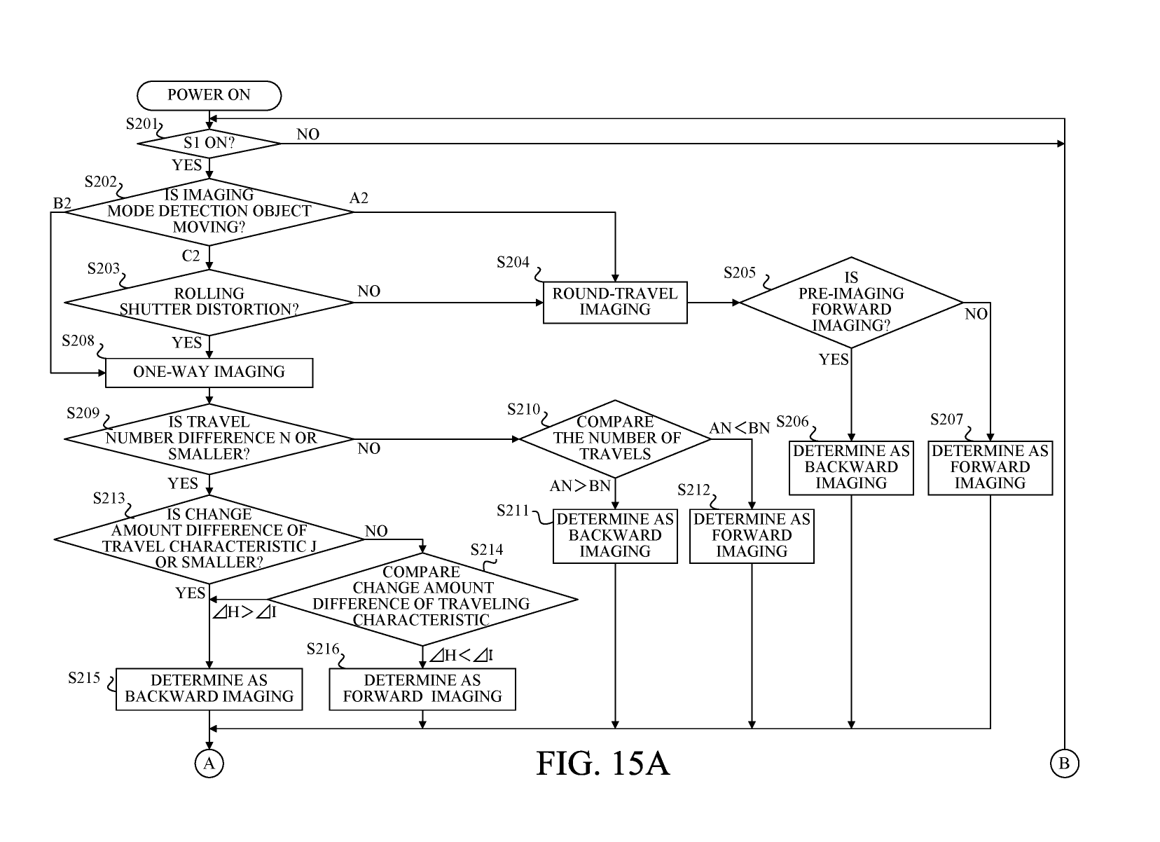

Referring now to FIG. 14, a description will be given of an imaging control according to this embodiment performed by the camera CPU 113 based on the information on the imaging, the traveling characteristics and the information on the number of travels of the shutter blades A and B. The information on the imaging contains the imaging mode information and the information of the object (imaging scene) as in the first embodiment.

The information acquisition unit 113a of the camera CPU 113 acquires the imaging mode information obtained from the imaging mode setting dial 112b in the switch unit 112 and image data into which the signal processing circuit 109 converts the image obtained by the imaging device 104. The information acquisition unit 113a acquires information (referred to as actual traveling characteristic information hereinafter) on the traveling characteristic of each of the current shutter blades A and B using the SH detection signals from the SH detection sensors 105c and 105d. The information acquisition unit 113a acquires information (referred to as SH traveling number information hereinafter) on a count value that counts the number of travels of each of the initial shutter blades A and B. The information acquisition unit 113a acquires the reference SH traveling characteristic information initially stored in the information storage unit 150.

The information acquisition unit 113a sends the acquired imaging mode information and image data to the scene determination unit 113b, and the actual SH traveling characteristic information and the reference SH traveling characteristic information to the SH traveling characteristic change amount calculation unit 113c. The information acquisition unit 113a sends the obtained SH traveling number information to the operation SH determining unit 113d.

Based on the imaging mode information received from the information acquisition unit 113a, the scene determination unit 113b determines whether the imaging control is to be the one-way imaging control or the round-travel imaging control, or is to be determined based on the information on the object (imaging scene) detected from the image data. The scene determination unit 113b obtains the height AY and the lateral moving speed AX of the object on the imaging screen as the information on the object and determines whether or not the rolling shutter distortion occurs using them or whether the imaging scene contains an object that causes the rolling shutter distortion. This determination is made by the method described in the first embodiment with reference to FIG. 8.

Based on the actual SH traveling characteristic information and the reference SH traveling characteristic information received from the information acquisition unit 113a, the SH traveling characteristic change amount calculation unit 113c calculates the traveling characteristic change amounts ΔH and ΔI of the shutter blades A and B, respectively. Then, it sends the comparison result of ΔH and ΔI to the operation SH determination unit 113d. Based on the imaging mode information and the determination result of the scene determination unit 113b, the motion SH determination unit 113d selects one of the one-way imaging control or the round-travel imaging control to be performed. When one-way imaging control is to be performed, the operation SH determination unit 113d selects one of the forward travel imaging control and the backward travel control to be executed based on the comparison result of ΔH and ΔI and the SH traveling number information acquired from the SH traveling characteristic change amount calculation unit 113c. The operation SH determination unit 113d determines the traveling direction (reset scanning direction) of the electronic front curtain based on the shutter blades to be operated.

The information on the imaging control determined by the operation SH determination unit 113d is transmitted to the shutter driving circuit 106 and the reset scanning direction of the electronic front curtain is transmitted to the vertical driving modulation circuit 108. Thereby, the imaging control using the electronic front curtain and the shutter blade (A or B) is performed.

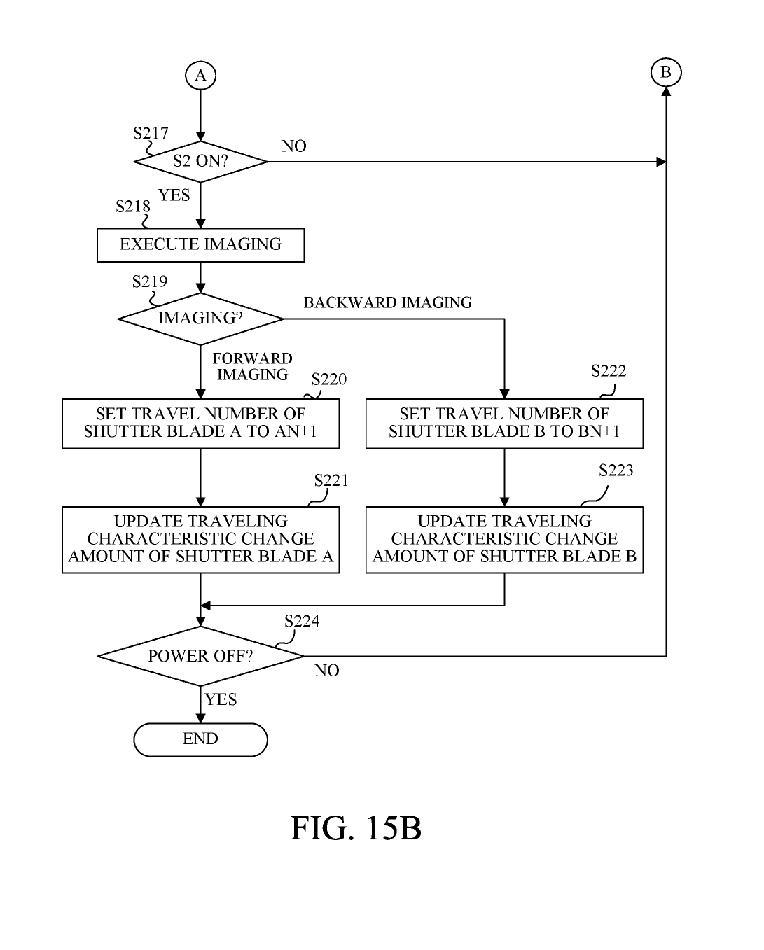

Referring now to flowcharts in FIGS. 15A and 15B, a description will be given of a flow of the above imaging control (imaging control method). The camera CPU 113 as a computer executes this processing in accordance with an imaging control program as a computer program. First, in the step S201, the camera CPU 113 when detecting that the SW1 in the release switch 112a turns on, proceeds to the step S202.

In the step S202, the camera CPU 113 detects the imaging mode set by the imaging mode setting dial 112b (obtains the imaging mode information), determines whether the detected imaging mode is one of an A2 mode, a B2 mode, and a C2 mode. As in the step S102 in the first embodiment, assume that a low-speed continuous capturing mode is the B2 mode, and a high-speed continuous capturing mode having a higher continuous capturing speed than that of the low-speed continuous capturing mode is the A2 mode. The mode for determining the imaging control based on the detection result of the object (imaging scene) is the C2 mode. When the imaging mode is the A2 mode, the camera CPU 113 proceeds to the step S204, and when it is the B2 mode, it proceeds to the step S208. When it is the C2 mode, the flow proceeds to the step S203.

In the step S203, the camera CPU 113 detects the information of the object (imaging scene) in the image data obtained by the image sensor 104. More specifically, similar to the step S103 in the first embodiment, the height AY of the object and the lateral moving speed AX on the imaging screen are detected. Then, it is determined whether the rolling shutter distortion occurs by the determination method described in the first embodiment using the height AY and the lateral travel speed AX. If it is determined that no rolling shutter distortion occurs, the flow proceeds to the step S204, and if it is determined that the rolling shutter distortion occurs, the flow proceeds to the step S208.

In the step S204, the camera CPU 113 determines the imaging control to be executed this time as the round-travel imaging control when the SW2 in the release switch 112a turns on, and proceeds to the step S205.

In the step S205, the camera CPU 113 determines whether the imaging control executed last time was the forward travel imaging control. If it was the forward travel imaging control, the flow proceeds to the step S206, and if it was the backward travel imaging control, the flow proceeds to the step S207.

In the step S206, the camera CPU 113 determines that the imaging control to be executed this time is the backward travel imaging control, and proceeds to the step S217.

In the step S207, the camera CPU 113 determines the imaging control to be executed this time as the forward travel imaging control, and proceeds to the step S217.

In the step S208, the camera CPU 113 determines that the imaging control to be executed this time is the one-way imaging control, and proceeds to the step S209.

In the step S209, the camera CPU 113 determines whether a difference between the number of travels AN of the shutter blades A and the number of travels BN of the shutter blades B indicated by the SH traveling number information is equal to or less than a predetermined number N of times. When |AN−BN|<N, the camera CPU 113 proceeds to the step S213, and if |AN−BN|<N, the flow proceeds to the step S210.

In the step S210, the camera CPU 113 compares the number of travels AN of the shutter blade A with the number of travels BN of the shutter blade B. If AN>BN, the flow proceeds to the step S211, and if AN<BN, the flow proceeds to the step S212.

In the step S211, the camera CPU 113 determines that the imaging control to be executed this time is the backward travel imaging control, and proceeds to the step S217.

In the step S212, the camera CPU 113 determines the imaging control to be executed this time as the forward travel imaging control, and proceeds to the step S217.

In the step S213, the camera CPU 113 calculates the traveling characteristic change amounts ΔH and ΔI of the shutter blades A and B respectively using the actual SH traveling characteristic information and the reference SH traveling characteristic information, and determines whether the difference between ΔH and ΔI is equal to or less than a predetermined value J. If |ΔH−ΔI|>J, the camera CPU 113 proceeds to the step S214, and if |ΔH−ΔI|>J, the flow proceeds to the step S215.

In the step S214, the camera CPU 113 determines a smaller one of the traveling characteristic change amounts ΔH and ΔI of the shutter blade A and the shutter blade B. If ΔH>ΔI, the flow proceeds to the step S215, and if ΔH>ΔI, the flow proceeds to the step S216.

In the step S215, the camera CPU 113 determines that the imaging control to be executed this time is the backward travel imaging control, and proceeds to the step S217.

In the step S216, the camera CPU 113 determines the imaging control to be executed this time as the forward travel imaging control, and proceeds to the step S217.

In the step S217, when the camera CPU 113 detects that the SW2 in the release switch 112a turns on, the flow proceeds to the step S218. Otherwise, the camera CPU 113 returns to the step S201.

In the step S218, the camera CPU 113 executes the imaging control determined in the step S216, and proceeds to the step S219.

In the step S219, the camera CPU 113 determines whether the imaging control executed this time is the forward travel imaging control or the backward travel imaging control. If it is the forward travel imaging control, the flow proceeds to the step S220, if it is the backward travel imaging control, the flow proceeds to the step S222.

In the step S220, the camera CPU 113 adds 1 to the number of travels AN of the shutter blades A and proceeds to the step S221.

In the step S221, the camera CPU 113 updates the traveling characteristic change amount ΔH of the shutter blade A and proceeds to the step S224.

In the step S222, the camera CPU 113 adds 1 to the number of travels BN of the shutter blades B and proceeds to the step S223.

In the step S223, the camera CPU 113 updates the traveling characteristic change amount ΔI of the shutter blade B, and proceeds to the step S224.

In the step S224, the camera CPU 113 determines whether the camera body 100 has been powered off by the main switch in the switch unit 112.

If the power is not turned off, the camera CPU 113 returns to the step S201, and when it is turned off, the camera CPU 113 ends this processing.

This embodiment describes acquiring the image data used by the scene determination unit 113b from the image sensor 104, but it may be acquired from the focusing image sensor 120 or a photometry image sensor. This embodiment describes that the camera CPU 113 determines one of the forward travel imaging control and the backward travel imaging control to be performed as the one-way imaging control, but the user may arbitrarily set it. The user may arbitrarily set which of the one-way imaging control and the round-travel imaging control is to be performed based on the information on the imaging.

Each of the above embodiments select the one-way imaging control or the round-travel imaging control based on the information on the imaging, and can improve the frame rate using the first and second mechanical shutters, suppressing the rolling shutter distortion.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention can provide an imaging apparatus that can improve a frame rate with a mechanical shutter while suppressing a rolling shutter distortion.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An imaging apparatus comprising:
an image sensor configured to photoelectrically convert light from an object;
a mechanical shutter configured to travel in a first direction and a second direction different from the first direction relative to an imaging plane of the image sensor; and
a control unit configured to control imaging about an operation of the mechanical shutter,
wherein the control unit provides a control so as to provide first imaging that causes the mechanical shutter to travel in the first direction in synchronization with an exposure of the image sensor and second imaging that causes the mechanical shutter to travel in the second direction in synchronization with the exposure of the image sensor, and
wherein the control unit determines whether to perform one of the first imaging and the second imaging or to perform both the first imaging and the second imaging continuously based on an imaging mode and predetermined information on an imaging scene, and controls the imaging in accordance with a determination result.

2. The imaging apparatus according to claim 1, wherein the second direction is opposite to the first direction.

3. The imaging apparatus according to claim 2, wherein the mechanical shutter includes a first mechanical shutter and a second mechanical shutter,
wherein the control unit causes both the first and second mechanical shutters to travel in the first direction to expose the image sensor for the first imaging, and to travel both the first and second mechanical shutters in the second direction to expose the image sensor for the second imaging.

4. The imaging apparatus according to claim 3, wherein the control unit provides the control to perform the first imaging or the second imaging in performing only the one of the first imaging and the second imaging.

5. The imaging apparatus according to claim 2, wherein the mechanical shutter includes a first mechanical shutter and a second mechanical shutter,
wherein the control unit performs the first imaging by a first electronic front curtain control that sequentially resets pixels in the image sensor in the first direction before the first mechanical shutter starts travelling in the first direction, and
wherein the control unit performs the second imaging by a second electronic front curtain control that sequentially reset the pixels in the image sensor in the second direction before the second mechanical shutter starts travelling in the second direction.

6. The imaging apparatus according to claim 1, wherein the predetermined information is information on an imaging mode set by a user,
wherein the imaging mode includes a low-speed continuous capturing mode and a high-speed continuous capturing mode having a continuous capturing speed higher than that of the low-speed continuous capturing mode, and
wherein the control unit performs one of the first imaging and the second imaging when the low-speed continuous capturing mode is set, and performs both of the first imaging and the second imaging when the high-speed continuous capturing mode is set.

7. The imaging apparatus according to claim 1, wherein the information on the imaging is information on the imaging scene,
wherein the information on the imaging scene includes at least one of information on a size of the object moving on an imaging plane in the first and second directions and information on a moving speed of the object in a direction orthogonal to the first and second directions.

8. The imaging apparatus according to claim 7, wherein the control unit provides a control so as to continue both the first imaging and the second imaging at least one of when the size of the object based on the information on the size of the object is larger than a predetermined value and when the moving speed of the object based on the information on the moving speed is higher than a predetermined speed.

9. The imaging apparatus according to claim 8, wherein the control unit detects respective traveling characteristics of the first and second mechanical shutters, counts the number of travels of each of the first and second mechanical shutters, and performs one of the first imaging and second imaging based on a change in the traveling characteristic and the number of travels of each of the first and second mechanical shutters when the one of the first imaging and second imaging is to be performed.

10. An imaging apparatus comprising:
an image sensor;
a mechanical shutter configured to travel in a first direction and a second direction different from the first direction relative to an imaging plane of the image sensor;
a control unit configured to control an exposure about an exposure operation using the image sensor; and
an acquisition unit configured to acquire predetermined information on at least one of the number of travels and a traveling characteristic of the mechanical shutter,
wherein the control unit provides a control so as to provide first imaging that causes the mechanical shutter to travel in the first direction in synchronization with an exposure of the image sensor and second imaging that causes the mechanical shutter to travel in the second direction in synchronization with the exposure of the image sensor, and
wherein when one of the first imaging and the second imaging is to be performed, the control unit determines based on the predetermined information which of the first imaging or the second imaging is to be performed, and controls the imaging in accordance with a determination result.

11. The imaging apparatus according to claim 10, wherein the mechanical shutter includes a first mechanical shutter and a second mechanical shutter,
wherein the control unit performs the first imaging by a first electronic front curtain control that sequentially resets pixels in the image sensor in the first direction before the first mechanical shutter starts travelling in the first direction, and
wherein the control unit performs the second imaging by a second electronic front curtain control that sequentially reset the pixels in the image sensor in the second direction before the second mechanical shutter starts travelling in the second direction.

12. A control method for an imaging apparatus that includes an image sensor configured to photoelectrically convert light from an object, and a mechanical shutter configured to travel in a first direction and a second direction different from the first direction relative to an imaging plane of the image sensor, the control method for the imaging apparatus comprising the step of controlling imaging about an operation of the mechanical shutter,
wherein the control step provides a control over first imaging that causes the mechanical shutter to travel in the first direction in synchronization with an exposure of the image sensor and second imaging that causes the mechanical shutter to travel in the second direction in synchronization with the exposure of the image sensor, and
wherein the control step determines whether to perform one of the first imaging and the second imaging or to perform both the first imaging and the second imaging continuously based on an imaging mode and predetermined information on an imaging scene, and controls the imaging in accordance with a determination result.

13. A control method for an imaging apparatus that includes an image sensor, and a mechanical shutter configured to travel in a first direction and a second direction different from the first direction relative to an imaging plane of the image sensor, the control method for the imaging apparatus comprising the steps:
controlling an exposure about an exposure operation using the image sensor; and
acquiring predetermined information on at least one of the number of travels and a traveling characteristic of the mechanical shutter,
wherein the control step provides a control over first imaging that causes the mechanical shutter to travel in the first direction in synchronization with an exposure of the image sensor and second imaging that causes the mechanical shutter to travel in the second direction in synchronization with the exposure of the image sensor, and
wherein when one of the first imaging and the second imaging is to be performed, the control step determines based on the predetermined information which of the first imaging or the second imaging is to be performed, and controls the imaging in accordance with a determination result.

14. A non-transitory computer-readable storage medium storing a computer program that enables a computer to execute a control method for an imaging apparatus that includes an image sensor configured to photoelectrically convert light from an object, and a mechanical shutter configured to travel in a first direction and a second direction different from the first direction relative to an imaging plane of the image sensor, the control method for the imaging apparatus comprising the step of controlling imaging about an operation of the mechanical shutter,
wherein the control step provides a control over first imaging that causes the mechanical shutter to travel in the first direction in synchronization with an exposure of the image sensor and second imaging that causes the mechanical shutter to travel in the second direction in synchronization with the exposure of the image sensor, and
wherein the control step determines whether to perform one of the first imaging and the second imaging or to perform both the first imaging and the second imaging continuously based on an imaging mode and predetermined information on an imaging scene, and controls the imaging in accordance with a determination result.

15. A non-transitory computer-readable storage medium storing a computer program that enables a computer to execute a control method for an imaging apparatus that includes an image sensor, and a mechanical shutter configured to travel in a first direction and a second direction different from the first direction relative to an imaging plane of the image sensor, the control method for the imaging apparatus comprising the steps:
controlling an exposure about an exposure operation using the image sensor; and
acquiring predetermined information on at least one of the number of travels and a traveling characteristic of the mechanical shutter,
wherein the control step provides a control over first imaging that causes the mechanical shutter to travel in the first direction in synchronization with an exposure of the image sensor and second imaging that causes the mechanical shutter to travel in the second direction in synchronization with the exposure of the image sensor, and
wherein when one of the first imaging and the second imaging is to be performed, the control step determines based on the predetermined information which of the first imaging or the second imaging is to be performed, and controls the imaging in accordance with a determination result.
